(19) United States
(12) Patent Application Publication
(10) Pub. No.: US 2024/0300858 A1
(43) Pub. Date: Sep. 12, 2024

(54) COMPLEX OXIDE THERMAL BARRIER COATINGS WITH LOW THERMAL INERTIA AND LOW THERMAL CONDUCTIVITY

(71) Applicant: Oerlikon Metco (US) Inc., Westbury, NY (US)

(72) Inventors: Tyler James HARRINGTON, New York, NY (US); Timothy Tadros SHAROBEM, Westbury, NY (US)

(21) Appl. No.: 18/260,100

(22) PCT Filed: Jan. 4, 2022
(86) PCT No.: PCT/US2022/011142

§ 371 Date: Jun. 30, 2023

Related U.S. Application Data
(60) Provisional application No. 63/134,009, filed on Jan. 5, 2021.

(51) Int. Cl. C04B 35/488

(52) U.S. Cl. CPC C04B 35/488; C04B 2235/3225; C04B 2235/3229; C04B 2235/3232; C04B 2235/3244; C04B 2235/3246; C04B 2235/9607; C04B 2235/9646

(57) ABSTRACT

Compositions of highly complex oxides that exhibit low thermal inertia, which lead to decreased heat loss and increased engine efficiency, are provided for temperature swing coatings. The compositions include at least five constituent oxides greater than 5 mol %. The oxides may form single phase solid solutions or may form multiple phases. The oxide coating may be mixed with additional phases or have a high porosity to further decrease thermal inertia. The oxides may contain at least five of any of the following metals and/or semimetals: Sc, Y, Ti, Zr, Hf, V, Nb, Ta, Cr, Mo, W, Mn, Re, Fe, Ru, Co, Ni, Cu, Zn, La, Ce, Pr, Nd, Pm, Sm, Eu, Gd, Tb, Dy, Ho, Er, Yb, Lu, Be, Mg, Ca, Sr, Ba, Al, Ga, Sn, Sb, Tl, Pb, Bi, B, Si, Ge, As, Sb, Te, or Po.

### CROSS-REFERENCE TO RELATED APPLICATION

This application claims the benefit and priority of U.S. Provisional Application No. 63/134,009 filed Jan. 5, 2021, the disclosure of which is expressly incorporated by reference herein in its entirety.

### BACKGROUND OF THE INVENTION

### 1. Field of the Disclosure

Thermal barrier coatings (TBCs) are ceramic based coatings which exhibit low thermal conductivity. It is generally desirable to minimize the thermal conductivity. Example embodiments of the present disclosure generally relate to a high entropy oxide (HEO) material that exhibits a low thermal conductivity for two applications: (1) temperature swing coatings used in combustion engines, and (2) TBCs used in aerospace/industrial gas turbine (IGT) components.

### 2. Background Information

When using high entropy oxides as temperature swing coatings for combustion engines, it is advantageous to have a low heat capacity and a low thermal conductivity. Combustion engines are more fuel efficient, if thermal loss through the engine block and pistons is minimized. This requires the use of a coating with a low thermal conductivity on the internal engine surfaces. The low thermal conductivity layer effectively retains the heat within the combustion chamber during a combustion event. However, if excessive heat builds in the cylinder walls and piston surfaces, then incoming fuel air mixture will become heated upon entering the combustion chamber, which can cause spontaneous ignition of unburnt gas ahead of the flame (knocking) or spontaneous pre-ignition of the fuel air mixture. This occurs when the coating resists rapid changes in temperatures and, thus, the temperature profile in the coating and engine block approaches steady state conditions during engine operation.

To prevent the temperature of the coating from reaching steady state, the coating must also have a low specific heat capacity. A combined low specific heat capacity and low thermal conductivity leads to a low thermal inertia. A low thermal inertia allows the temperature of the coating to “swing”-meaning that the coating surface is hot when the combustion event happens and cools rapidly before the next stroke of the engine intakes fuel, which prevents heating of the fuel/air mixture. A coating with a low thermal inertia will both limit the amount of heat transfer through the coating to the surroundings and will retain very little heat on the surface walls. In addition to increased fuel efficiency, the coating provides a higher hardness, increased cavitation, and wear resistance for the coated engine components.

When using high entropy oxides as thermal barrier coatings for aerospace/IGT applications, it is advantageous for the material to simultaneously possess a high toughness and a low thermal conductivity. TBC toughness is typically measured by furnace cycle testing (FCT), whereby the coating is subjected to a cycle of hot and cold temperatures. Tougher coatings can survive many cycles before failure.

High entropy oxides have been synthesized and suggested for TBC applications. However, the engineering of high entropy oxides and their use as “temperature swing” coatings are not known. Furthermore, the concept of thermal inertia engineering in complex oxides for temperature swing properties is not known. Furthermore, the design of high entropy oxides specific to a low thermal conductivity in combination with high toughness is not known.

It can be appreciated that the high entropy oxides encapsulate millions of different potential material compositions, and there are certain properties which are not inherent to high entropy oxides. Such properties include thermal conductivity, specific heat, and toughness.

### SUMMARY

In example embodiments, the present disclosure provides a class of oxide coating compositions that can be applied via thermal spray techniques to engine components of any composition, which exhibit low thermal inertia and effective temperature swing properties. The coating allows for increased fuel efficiency in combustion engines.

Example embodiments of the present disclosure relate to a high entropy oxide (HEO) material as temperature swing coating. In embodiments, the HEO material allows for precise tunability of chemical, mechanical, and thermal properties for use in specific environments. In embodiments, HEO materials contain high concentrations (>5 mol %) of at least five oxide constituents. The chemical disorder in the oxide systems creates significant phonon scattering leading to an inherently low thermal conductivity. Compositional control allows for compositions with low specific heat capacity and, therefore, low thermal inertia, which is defined as the square root of the product of the heat capacity, thermal conductivity, and density.

The compositions that maximize atomic size and mass variance provide the most phonon scattering and the lowest thermal conductivity. Compositions with the lowest average atomic mass have the lowest specific heat capacity and density. The proper combination of low thermal conductivity and low heat capacity provides the disclosed oxides with low thermal inertia and good temperature swing properties.

### DETAILED DESCRIPTION

In an embodiment, compositions of mixed oxides containing at least five different binary oxides at more than 5 mol % are used as temperature swing coatings in combustion engines. In an embodiment, the complex oxide is represented by General Formula of MₓO_{y}, where M represents a group of at least 5 different oxide-forming metallic cations, x represents the number of metal cations (M) or atoms, and y represents the number of oxygen anions (O) or atoms.

In embodiments of the present disclosure, at least five different oxide-forming metallic cations (M) may include:
at least one alkaline earth metal, including Be, Mg, Ca, Sr, and Ba;
at least one, preferably at least two, of the following transition metals: Sc, Y, Ti, Zr, Hf, V, Nb, Ta, Cr, Mo, W, Mn, Re, Fe, Ru, Co, Ni, Cu, and Zn;
one or more post-transition metals, including Al, Ga, Sn, Sb, Tl, Pb, and Bi;
one or more of the lanthanides, including La, Ce, Pr, Nd, Pm, Sm, Eu, Gd, Tb, Dy, Ho, Er, Yb, and Lu; and
one or more semimetals, including B, Si, Ge, As, Sb, Te, and Po.

In embodiments, the following metals may be used in low thermal inertia complex oxide automotive TBCs: (1) alkaline earth metals, such as Mg and Ca: (2) transition metals, such as Y, Ti, Zr, Hf, Cr, Mo, Mn, Fe, Co, Ni: (3) post transition metals, such as Al and Sn: (4) lanthanides, such as La, Ce, Gd, Dy, and Yb; and (5) semimetals, such as Si.

In embodiments, the compositions may form single-phase solid solutions or multi-phase systems.

The above-described compositions reduce the thermal conductivity of the coatings by increasing mass and strain disorder in the sample compositions by using individual atoms that vary significantly in size and mass. The calculations of the exact mass and strain variance and average atomic mass for each of the >100,000 compositions of interest are carried out with the aid of software. The calculated values can then be sorted graphically to determine the compositions in the space with the minimum thermal inertia.

The mass scattering value is calculated from formula (1), whereby mᵢ is the atomic mass of the i^{th} element, and m̅ is the average atomic mass of all n elements:

$$Γ = 100 \sqrt{{\sum }_{i = 1}^{n} {( 1 - \frac{{m}_{i}}{\overline{m}} )}^{2}}$$

It has been found that a mass scattering of greater than 35 from the above equation results in a thermal conductivity value below 1 W m⁻¹ K⁻¹ when the oxide is a single phase. It can be appreciated that a collection of 5 or more oxides does not inherently form a single phase, and only 3 of the 8 oxide experiments evaluated exhibited a single-phase structure.

In some embodiments, the mass scattering value for the high entropy oxide composition is 35 or higher. In preferred embodiments, the mass scattering value for the high entropy oxide is 40 or higher. In more preferred embodiments, the mass scattering value for the high entropy oxide is 42.5 or higher.

It has been found that the total scattering value is also a good predictor for the thermal conductivity of the oxide composition. Higher total scattering values equate to lower thermal conductivity values. The total scattering of an oxide composition is calculated as the sum of the mass scattering value, described above, and the strain scattering. The strain scattering, δ, is calculated from formula (2), whereby cᵢ is the composition, rᵢ is the ionic radius of the iₜₕ cation in the oxide system, and n is the total number of cations in the system:

$$δ = \sqrt{{\sum }_{i = 1}^{n} {{c}_{i} ( 1 - \frac{{r}_{i}}{\overline{r}} )}^{2}}$$

In some embodiments, the total scattering value for the high entropy oxide composition is 30 or higher. In preferred embodiments, the total scattering value for the high entropy oxide is 35 or higher. In more preferred embodiments, the total scattering value for the high entropy oxide is 40 or higher.

To achieve excellent temperature swing properties, a coating material should have a thermal conductivity of less than 3.0 W m⁻¹ K⁻¹, preferably less than 1.5 W m⁻¹ K⁻¹, and more preferably less than 0.8 W m⁻¹ K⁻¹.

In some embodiments, the present disclosure constitutes a “temperature swing” coating. A temperature swing coating is defined as a coating composition with a thermal inertia of less than 3.0 J m⁻² K⁻¹ s^{-1/2}, preferably less than 2.0 J m⁻² K⁻¹ s^{-1/2}, and more preferably less than 1.5 J m⁻² K⁻¹ s^{-1/2}.

To achieve excellent temperature swing properties, a coating material should have a specific heat capacity and low thermal conductivity of less than 900 J kg⁻¹ K⁻¹, preferably less than 600 J kg⁻¹ K⁻¹, and more preferably less than 600 J kg⁻¹ K⁻¹.

To achieve excellent toughness properties, the alloy should possess a tetragonal structure, which possesses excellent toughness. However, there is a certain limit to the dopant concentration to a common tetragonal oxide, such as zirconia, before which the structure becomes a less tough cubic structure. A typical dopant concentration is roughly 7-10%. However, the high entropy oxide space enables the utilization of higher dopant concentrations while maintaining the tetragonal structure, although tetragonality is not an inherent feature of high entropy oxides.

Oxide vacancy concentration is presented as a technique to determine the tetragonality of the oxide material. In some embodiments, the oxide vacancy concentration is below 0.05. In preferred embodiments, the oxide vacancy concentration is below 0.0375. In more preferred embodiments, the oxide vacancy concentration is below 0.025.

TBC toughness is commonly measured via furnace cycle testing (FCT) intended to simulate the cyclic thermal stresses associated with the heating and cooling of a turbine engine. In such FCT testing, a MCrAlY bond coat is typically used to evaluate TBC materials.

When applied as a thermal barrier coating, the primary complex oxide may optionally be mixed with additional phases, such as metallic alloys, oxides, and/or carbides. The primary complex oxide may optionally be applied to a surface with various levels of relative density (i.e. porosity) to decrease thermal inertia. The coatings may be applied to the internal cylinder surfaces of homogeneous charge with spark ignition (HCSI), and/or stratified charge with compression ignition (SCCI), and/or homogeneous charge compression ignition (HCCI) type engines. The engines may be two or four stroke engines. In some embodiments, the coatings are applied directly to the piston or engine block. In one embodiment, the oxide coating is applied on top of an intermediate bond coat (e.g., a MCrAlY composition). The thermal barrier coating topcoat may be applied by thermal spray techniques, such as, but not limited to, high velocity oxygen fuel (HVOF), atmospheric plasma spray (APS), physical vapor deposition (PVD), etc.

### EXAMPLES

In some embodiments the HEO TBCs include:
50-90 wt % ZrO₂;
0.5-8 wt % MgO and/or TiO₂;
0.5-10 wt % Y₂O₃; and
total remaining oxides include 3-20 wt % of Yb₂O₃, La₂O₃, Gd₂O₃, Dy₂O₃, HfO₂, and CeO₂.

In one preferred embodiment, named HEO-4, the HEO TBC includes:
7.5-11.5 wt % Y₂O₃;
13-20 wt % M₂O₃ (most preferably Yb₂O₃);
17-26 wt % MO₂ (most preferably Ti₂O₂ and/or CeO₂), more preferably, 5-9 wt % TiO₂, and 11-18 wt % CeO₂; and
a balance of ZrO₂.

In another preferred embodiment, named HEO-7, the HEO TBC includes:
6-9 wt % MO (preferable MgO);
0.5-1.5 wt % Y₂O₃;
2.5-4 wt % M₂O₃ (most preferably M=La, or Gd), more preferably including 1-2 wt % La₂O₃, and 1-3 wt % Gd₂O₃; and a balance of ZrO₂.

In another preferred embodiment, named HEO-8, the HEO TBC includes:
0.4-0.6 wt % MO (preferable MgO);
1.2-1.8 wt % Y₂O₃;
5.5-9 wt % M₂O₃ (most preferably M=Yb, La, Gd, or Dy), more preferably including 2-4 wt % Yb₂O₃, 2-4 wt % La₂O₃, and 2-3 wt % Dy₂O₃;
13-21 wt % MO₂ (most preferably CeO₂, HfO₂, or TiO₂), more preferably 2.5-4 wt % CeO₂ and 6.6-9.8 wt % HfO₂, 13-21 wt % CeO₂, or 2.5-4 wt % TiO₂, and 6.6-9.8 wt % CeO₂; and a balance of ZrO₂.

In another preferred embodiment, named HEO-12, the HEO TBC includes: 17-26 wt % M₂O₃ (most preferably Yb₂O₃ and Sm₂O₃), more preferably 12-20 wt % Yb₂O₃, and 3-6 wt % Sm₂O₃;
13.5-20.5 wt % MO₂ (preferably CeO₂); and
6-9 wt % M₂O₅ (preferably Nb₂O₅).

Table 1 below shows the calculated mass scattering, strain scattering, total scattering values, and the oxide vacancy concentration for oxides according to example embodiments. As discussed above, HEO-4, HEO-7, HEO-12, HEO-8A, HEO-8B, and HEO-8C represent exemplary embodiments of the present disclosure. These exemplary embodiments have a novel and nonobvious combination of a high total scattering value and a low oxide vacancy concentration that satisfy the technical embodiments of the present disclosure. As shown in Table 1, most of the HEOs tested do not have this combination of properties and, thus, high total scattering and low oxide vacancy concentration are not inherent properties of high entropy oxides. A standard thermal barrier coating material and yttria stabilized zirconia (YSZ) are also included in Table 1 and do not satisfy the total scattering parameter described herein.

TABLE 1

| | Mass | Strain | Total | Oxide Vacancy |
|---|---|---|---|---|
| Material | Scattering | Scattering | Scattering | Concentration |
| HEO-1 | 42.6 | 10.9 | 53.5 | 0.25 |
| HEO-2 | 44.3 | 9.1 | 53.4 | 0.25 |
| HEO-3 | 26.4 | 9.9 | 36.3 | 0.2 |
| HEO-4 | 33.4 | 10.2 | 43.6 | 0.06 |
| HEO-5 | 50.2 | 12.7 | 62.9 | 0.25 |
| HEO-6 | 46.5 | 10.7 | 57.2 | 0.2 |
| HEO-7 | 36.1 | 4.8 | 40.9 | 0.11 |
| HEO-8 | 28.9 | 7.7 | 36.6 | 0.04 |
| HEO-9 | 44 | 13 | 57 | 0.15 |
| HBO-10 | 52.4 | 10.2 | 62.6 | 0.29 |
| HBO-11 | 20.6 | 12.2 | 32.8 | 0.33 |
| HBO-12 | 27.4 | 9.1 | 36.5 | 0.01 |
| HEO-8A | 23.6 | 7.5 | 31.1 | 0.03 |
| HEO-8B | 25.7 | 8 | 33.7 | 0.03 |
| HEO-8C | 23.3 | 7.6 | 30.9 | 0.03 |
| YSZ | 0.7 | 5.5 | 6.2 | 0.02 |

All HEOs presented in Table 1 were manufactured in a similar manner via a spray drying technique, sintered for 1400° C. at 10 hours, and plasma sprayed onto a substrate. In all samples, a MCrAlY bond coat was used as the initial layer on the substrate. Then, each HEO was directly sprayed onto the bond coat in one set of experiments. In a second set of experiments, a standard 8 YSZ coating was applied as an intermediate layer onto the bond coat, and the HEO coating was applied as the top coating. The resultant coatings were used in subsequent physical testing, including thermal conductivity, before and after sintering, and furnace cycle testing (FCT) life. The use or lack thereof of the intermediate YSZ layer is relevant to the FCT lifetimes.

The coating properties of oxides according to example embodiments are shown below in Table 2. The thermal conductivity value is expressed in W/mK and FCT results are expressed in cycles. As shown in Table 2, it is novel and nonobvious for the HEO coatings to have excellent toughness as demonstrated by a high FCT cycle life. A high FCT cycle life only corresponds to the HEO compositions that have low oxygen vacancy concentrations.

TABLE 2

| | Thermal | | |
|---|---|---|---|
| HEO # | Conductivity | FCT w/YSZ | FCT w/o YSZ |
| 1 | 1.22 | <20 | <20 |
| 2 | 1.3 | <20 | <20 |
| 3 | 1.21 | <20 | <20 |
| 4 | 0.77 | <20 | <20 |
| 5 | 1.29 | <20 | 20-60 |
| 6 | 1.04 | <20 | <20 |
| 7 | 0.93 | 96-116 | 60-96 |
| 8 | 0.91 | 240-260 | 370-390 |
| 9 | 1.26 | 104 | <20 |
| 10 | 1.18 | <20 | <20 |
| 18 | 1 | 100 | 85 |
| 12 | 0.95 | 1035 | 20 |
| 8A | 1 | 920+ | 73 |
| 8B | 1 | 1050+ | 477 |
| 8C | 1 | 950+ | 53 |

In some embodiments, the HEO coatings have FCT lifetimes above 200 cycles when sprayed directly onto a bond coat. In preferred embodiments, the HEO coatings have FCT lifetimes above 250 cycles when sprayed directly onto a bond coat. In still preferred embodiments, the HEO coatings have FCT lifetimes above 300 cycles when sprayed directly onto a bond coat.

In some embodiments, the HEO coatings have FCT lifetimes above 200 cycles when sprayed onto an intermediate 8YSZ layer, which is itself sprayed onto a bond coat. In preferred embodiments, the HEO coatings have FCT lifetimes above 500 cycles when sprayed onto an intermediate 8YSZ layer, which is itself sprayed onto a bond coat. In still preferred embodiments, the HEO coatings have FCT lifetimes above 900 cycles when sprayed onto an intermediate 8YSZ layer, which is itself sprayed onto a bond coat.

Further, at least because the invention is disclosed herein in a manner that enables one to make and use it, by virtue of the disclosure of particular exemplary embodiments, such as for simplicity or efficiency, for example, the invention can be practiced in the absence of any additional element or additional structure that is not specifically disclosed herein.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A high entropy oxide (HEO) material comprising a thermal conductivity lower than 1.5 W m⁻¹ K⁻¹.

2. The HEO material of claim 1, further comprising a total scattering value above 35.

3. The HEO material of claim 1, further comprising a total scattering value above 30.

4. The HEO material of claim 1, further comprising a specific heat capacity of less than 3.0 J m⁻² K⁻¹ s^{-1/2}.

5. The HEO material of claim 1, further comprising a specific heat capacity of less than 900 J kg⁻¹ K⁻¹.

6. The HEO material of claim 1, wherein greater than 90% of the HEO material is a tetragonal structure.

7. The HEO material of claim 1, wherein the HEO material has an oxide vacancy concentration of 0.05 or less.

8. The HEO material of claim 1, further comprising the use of the material to form a thermal barrier coating.

9. The HEO material of claim 1, further comprising the use of the material to form a coating for combustion chambers.

10. The HEO material of claim 1, wherein the HEO material is represented by General Formula of MₓO_{y}, where M represents a group of at least five different oxide-forming metallic cations, x represents the number of metal cations (M) or atoms, and y represents the number of oxygen anions (O) or atoms.

11. The HEO material of claim 1, wherein the HEO material is represented by General Formula of MₓO_{y}, where M represents at least one member of Group II of the Periodic Table, x represents the number of metal cations (M) or atoms, and y represents the number of oxygen anions (O) or atoms.

12. The HEO material of claim 1, wherein the HEO material is represented by General Formula of MₓO_{y}, where M represents at least one lanthanide, x represents the number of metal cations (M) or atoms, and y represents the number of oxygen anions (O) or atoms.

13. The HEO of claim 1, wherein the HEO material is represented by General Formula of MₓO_{y}, where M represents at least one transition metal, x represents the number of metal cations (M) or atoms, and y represents the number of oxygen anions (O) or atoms.

14. The HEO material of claim 1, wherein the HEO material comprises:
7.5-11.5 wt % Y₂O₃;
13-20 wt % M₂O₃ oxides;
17-26 wt % MO₂ oxides; and
a balance of ZrO₂.

15. The HEO material of claim 1, wherein the HEO material comprises:
6-9 wt % MO oxides;
0.5-1.5 wt % Y₂O₃;
2.5-4 wt % M₂O₃ oxides; and
a balance of ZrO₂.

16. The HEO material of claim 1, wherein the HEO material comprises:
7.5-11.5 Y₂O₃;
13-20 wt % M₂O₃ oxides;
17-26 wt % MO₂ oxides; and
a balance of ZrO₂.

17. An HEO material comprising:
0.4-0.6 wt % MO oxides;
1.2-1.8 wt % Y₂O₃;
5.5-9 wt % M₂O₃ oxides;
2-4 wt % MO₂ oxides; and
a balance of ZrO₂.

18. The HEO material of claim 1, wherein the HEO material comprises:
0.4-0.6 wt % MO oxides;
1.2-1.8 wt % Y₂O₃;
5.5-9 wt % M₂O₃ oxides;
13-21 wt % MO₂ oxides; and
a balance of ZrO₂.

19. The HEO material of claim 18, wherein the MO oxides are MgO, wherein the M₂O₃ oxides are selected from the group consisting of Yb₂O₃, La₂O₃, Gd₂O₃, and Dy₂O₃, and wherein the MO₂ oxides are selected from the group consisting of CeO₂, HfO₂, and TiO₂.
